(19) United States
(12) Patent Application Publication
(10) Pub. No.: US 2026/0288119 A1
(43) Pub. Date: Sep. 24, 2026

(54) MANUFACTURING INFORMATION MANAGEMENT DEVICE AND MANUFACTURING INFORMATION MANAGEMENT METHOD

(71) Applicant: FANUC CORPORATION, Minamitsuru-gun, Yamanashi (JP)

(72) Inventor: Nobuhiro HARA, Yamanashi (JP)

(21) Appl. No.: 19/479,939

(22) PCT Filed: Jun. 27, 2023
(86) PCT No.: PCT/JP2023/023879

§ 371 Date: Oct. 29, 2025

(51) Int. Cl. G05B 19/418

(52) U.S. Cl. CPC G05B 19/4183; G05B 2219/37576

(57) ABSTRACT

The present invention links manufacturing instructions from a production management system with manufacturing results of equipment and easily organizes the linked information thereof. This manufacturing information management device comprises: a manufacturing instruction acquisition unit that acquires a manufacturing instruction for a piece of equipment; a manufacturing results acquisition unit that acquires a manufacturing result of the equipment; and a linking unit that links the manufacturing instruction and the manufacturing result on the basis of a preset linking condition.

### TECHNICAL FIELD

The present disclosure relates to a manufacturing information management device and a manufacturing information management method for associating manufacturing instructions for facilities and manufacturing results achieved in the facilities with each other.

### BACKGROUND ART

There is a known system that operates industrial machines such as a machine tool and a robot based on manufacturing instructions from a production management system and collects results achieved in accordance with the instructions. For example, see Patent Document 1.

### Citation List

### Patent Document

Patent Document 1: Japanese Unexamined Patent Application, Publication No. 2007-172522

### DISCLOSURE OF THE INVENTION

### Problems to Be Solved by the Invention

However, in a case where the production management system and the industrial machines do not have a function of operating based on manufacturing instructions or are not configured to do so, manufacturing result data corresponding to manufacturing instructions cannot be automatically collected unless improvements are made to both the production management system and the industrial machines. In this case, for example, an operator has to record the results on a manufacturing instruction sheet of paper or the like. Furthermore, even in the case where an operator records the results, there may be disadvantages that the recorded contents are not necessarily accurate, the recording is time-consuming, and so on. Further, where numerical control devices are concerned, when a numerical control device cannot receive workpiece information (i.e., the numerical control device does not have such a function or is not linked with a production management system, etc.), it is difficult to associate manufacturing instructions with machining-related data that can be acquired from the numerical control device.

Therefore, it is desired to make it easy to organize manufacturing instructions from a production management system by associating the manufacturing instructions with manufacturing results achieved in facilities.

### Means for Solving the Problems

One aspect of a manufacturing information management device of the present disclosure includes: a manufacturing instruction acquisition unit that acquires manufacturing instructions for a facility; a manufacturing result acquisition unit that acquires manufacturing results achieved in the facility; and an association unit that associates the manufacturing instructions with the manufacturing results based on preset association conditions.

One aspect of a manufacturing information management method of the present disclosure is for causing a computer to function as a manufacturing information management device, and includes: a manufacturing instruction acquisition step of acquiring manufacturing instructions for a facility; a manufacturing result acquisition step of acquiring manufacturing results achieved in the facility; and an association step of associating the manufacturing instructions with the manufacturing results based on preset association conditions.

### BRIEF DESCRIPTION OF THE DRAWINGS

FIG. 1 is a diagram illustrating an example of a configuration of a manufacturing result management system according to one embodiment.

FIG. 2A is a table illustrating an example of manufacturing instructions.

FIG. 2B is a table illustrating an example of manufacturing instructions.

FIG. 2C is a table illustrating an example of manufacturing instructions.

FIG. 3 is a diagram illustrating an example of manufacturing data.

FIG. 4 is a table illustrating an example of manufacturing result generation conditions.

FIG. 5 is a diagram illustrating an example of a relationship between facilities and process steps on a per workpiece type basis.

FIG. 6 is a table illustrating an example of association conditions.

FIG. 7 is a diagram illustrating an example of a result generation condition list screen.

FIG. 8 is a diagram illustrating an example of a new creation screen.

FIG. 9 is a table illustrating an example of manufacturing results.

FIG. 10 is a table illustrating an example of manufacturing results.

FIG. 11 is a table illustrating an example of manufacturing results.

FIG. 12 is a diagram illustrating an example of a manufacturing result list screen.

FIG. 13 is a diagram illustrating an example of an association condition list screen.

FIG. 14 is a diagram illustrating an example of a new creation screen.

FIG. 15 is a diagram illustrating an example of an association outcome list screen.

FIG. 16 is a diagram illustrating an example of a manufacturing result association change screen.

FIG. 17 is a flowchart illustrating manufacturing result generation processing by a manufacturing information management device.

FIG. 18 is a flowchart illustrating association processing by the manufacturing information management device.

### PREFERRED MODE FOR CARRYING OUT THE INVENTION

### One Embodiment

A manufacturing result management system according to one embodiment will be described below in detail with reference to the drawings. The following describes, as an example, a manufacturing result management system in a metalworking factory employing job-shop production and equipped with a plurality of facilities, which are industrial machines such as machine tools and robots, arranged therein. It should be noted that the application of the present invention is not limited to metalworking factories, and the present invention is applicable to any factory having a plurality of facilities. Furthermore, the present invention is applicable to various machines as industrial machines such as machine tools, industrial robots, service robots, forging machines, laser processing machines, injection molding machines, and the like.

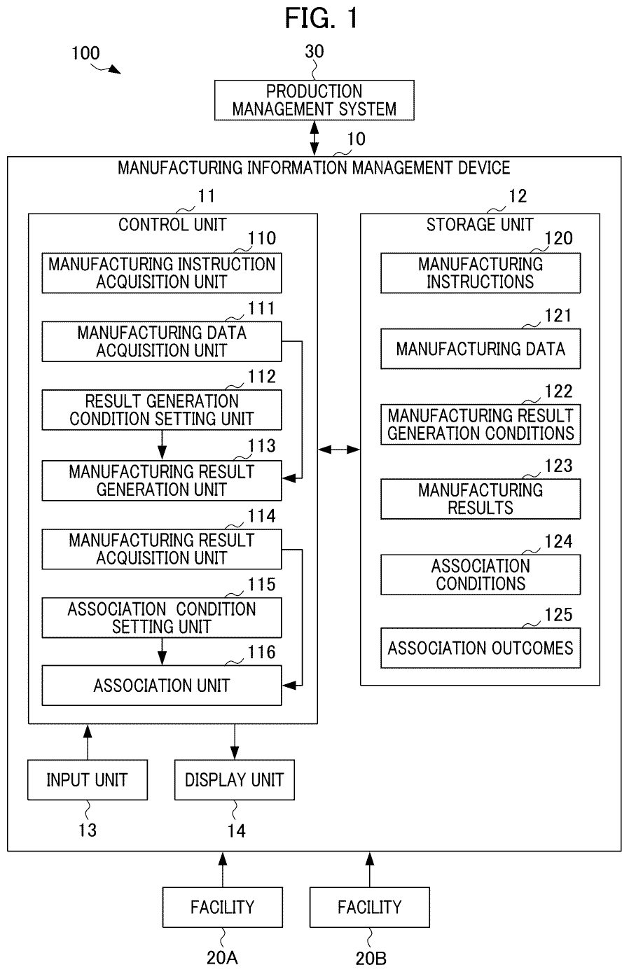

FIG. 1 is a diagram illustrating an example of a configuration of a manufacturing result management system according to one embodiment. As illustrated in FIG. 1, the manufacturing result management system 100 includes, for example, a manufacturing information management device 10, two facilities 20A and 20B, and a production management system 30. The manufacturing result management system 100 may include two or more facilities. The manufacturing information management device 10, the facilities 20A and 20B, and the production management system 30 are connected to each other via a network (not shown) such as a local area network (LAN) or the Internet to communicate with each other. In this case, the manufacturing information management device 10, the facilities 20A and 20B, and the production management system 30 each include a communication unit (not shown) for communicating with each other through such connection. The manufacturing information management device 10, the facilities 20A and 20B, and the production management system 30 may be directly connected to each other via a connection interface (not shown).

The production management system 30 is, for example, a server or the like. As will be described later, the production management system 30 transmits manufacturing instructions for the facilities 20A and 20B to the manufacturing information management device 10, monitors the operation states of the facilities 20A and 20B, and performs other functions.

The facilities 20A and 20B are, for example, known industrial machines such as machine tools or robots. The facilities 20A and 20B operate in response to control instructions outputted from a numerical control device or a robot control device (not shown) that executes a machining program based on the manufacturing instructions from the production management system 30. The facilities 20A and 20B output manufacturing data including at least time-series data related to manufacture that is based on the control instructions, to the manufacturing information management device 10 (to be described later). In the following description, the facility 20A is also referred to as “facility A” and the facility 20B is also referred to as “facility B”.

The manufacturing information management device 10 is a known computer device or the like, and acquires the manufacturing data from each of the facilities 20A and 20B that operate based on manufacturing commands from the production management system 30. From the acquired manufacturing data, the manufacturing information management device 10 generates manufacturing results on a per unit of manufacturing management basis, based on preset manufacturing result generation conditions, and manages the generated manufacturing results. The unit of manufacturing management indicates a process step for each workpiece type. Furthermore, the manufacturing information management device 10 associates the manufacturing instructions from the production management system 30 with the generated manufacturing results on the per unit of manufacturing management basis, based on preset association conditions. As illustrated in FIG. 1, the manufacturing information management device 10 includes a control unit 11, a storage unit 12, an input unit 13, and a display unit 14. The control unit 11 includes a manufacturing instruction acquisition unit 110, a manufacturing data acquisition unit 111, a result generation condition setting unit 112, a manufacturing result generation unit 113, a manufacturing result acquisition unit 114, an association condition setting unit 115, and an association unit 116.

### Storage Unit 12

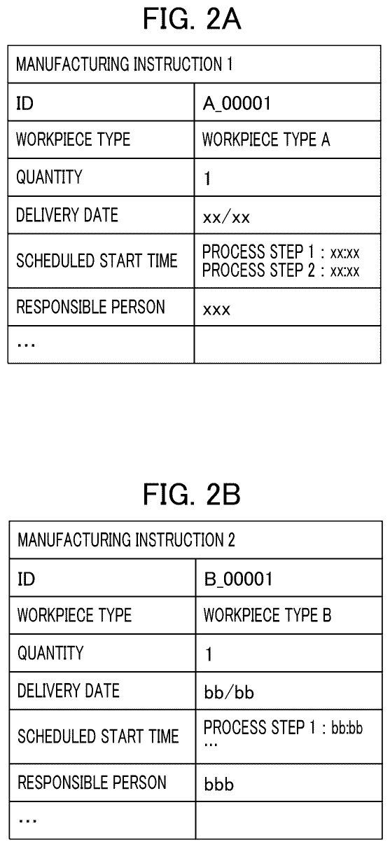

The storage unit 12 is a read only memory (ROM), a random access memory (RAM), a solid state drive (SSD), a hard disk drive (HDD), or the like. The storage unit 12 may store therein a program for manufacturing result management, a program for association processing, and the like. The storage unit 12 includes manufacturing instructions 120, manufacturing data 121, manufacturing result generation conditions 122, manufacturing results 123, association conditions 124, and association outcomes 125. The manufacturing instructions 120 include manufacturing instructions for the facilities 20A and 20B from the production management system 30, which are acquired by the manufacturing instruction acquisition unit 110 (to be described later). FIGS. 2A to 2C are tables each illustrating an example of the manufacturing instructions. FIGS. 2A and 2C illustrate manufacturing instructions for “process steps 1 and 2 for workpiece type A”. FIG. 2B illustrates a manufacturing instruction for “process step 1 for workpiece type B”. The manufacturing instructions 120 are information related to manufacturing plans on the per unit of manufacturing management basis, and each include storage areas for “ID”, “Workpiece Type”, “Quantity”, “Delivery Date”, “Scheduled Start Time”, “Responsible Person”, and the like. Each storage area for “ID” in the manufacturing instructions 120 stores, for example, identification information for identifying a manufacturing instruction (for example, a combination of a workpiece type “A” or “B” and a serial number). The “ID” is not limited to such a combination of a workpiece type and a serial number, and may be only a serial number or the like. Each storage area for “Workpiece Type” in the manufacturing instructions 120 stores “A”, “B”, or the like that indicates the workpiece type as information regarding the product to be manufactured. Each storage area for “Quantity” in the manufacturing instructions 120 stores the quantity of products to be manufactured in accordance with the respective manufacturing instruction. Each storage area for “Scheduled Start Time” in the manufacturing instructions 120 stores the scheduled start time for a process step for the respective workpiece type as information regarding the manufacturing time. Each storage area for “Responsible Person” in the manufacturing instructions 120 stores the name or responsible person ID of a responsible person who issued the manufacturing instruction in the production management system 30, as information regarding the person responsible for the manufacture. The manufacturing instructions 120 may include information regarding a manufacturing method, information regarding manufacturing location and facility, and the like.

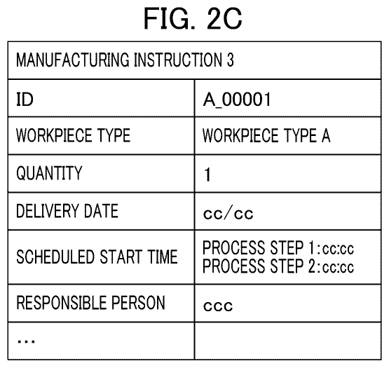

The manufacturing data 121 includes at least manufacture-related time-series data acquired from each of the facilities 20A and 20B by the manufacturing data acquisition unit 111 (to be described later). FIG. 3 is a diagram illustrating an example of the manufacturing data 121. In FIG. 3, the upper portion represents manufacturing data acquired from the facility 20A (facility A), and the lower portion represents manufacturing data acquired from the facility 20B (facility B). As illustrated in FIG. 3, the manufacturing data 121 includes time-series data related to a machining program executed to cause the facility 20A to perform manufacturing operation, and time-series data related to a door open signal and a door close signal for a door of the facility 20A. Further, the manufacturing data 121 includes time-series data related to a torque command for the facility 20B to perform manufacturing operation, and time-series data relate to a signal A and a signal B for the facility 20B. The manufacturing data 121 may include manufacture-related video data, manufacture-related audio data, data manually inputted by an operator, or the like.

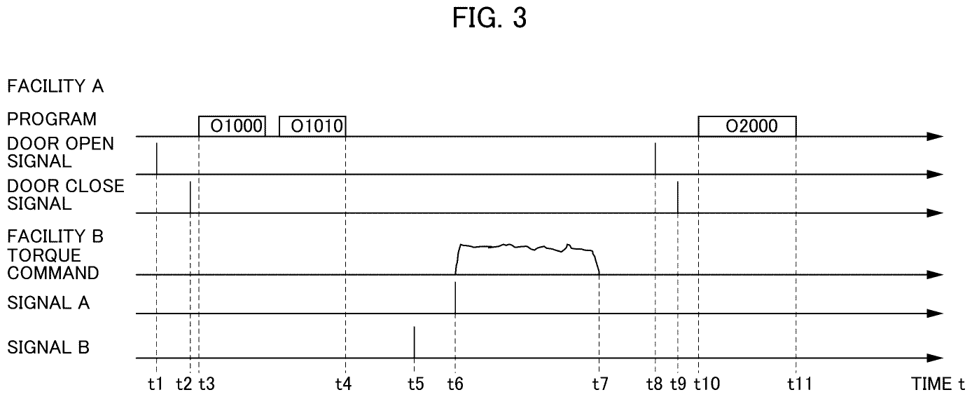

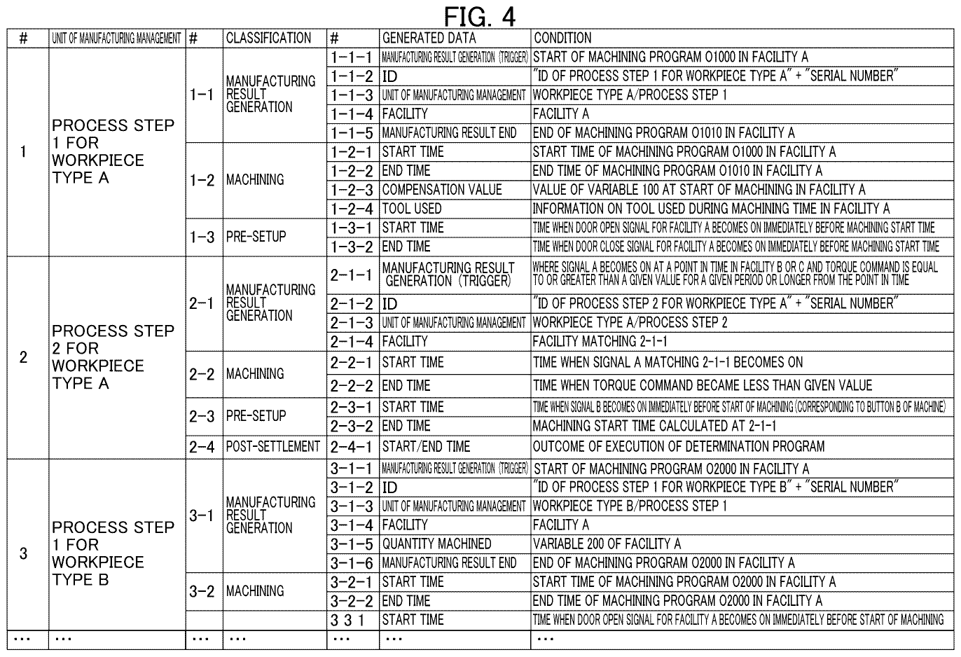

The manufacturing result generation conditions 122 include manufacturing result generation conditions set by the result generation condition setting unit 112 (to be described later). FIG. 4 is a table illustrating an example of the manufacturing result generation conditions 122. As illustrated in FIG. 4, the manufacturing result generation conditions 122 include storage areas for “Unit of Manufacturing Management”, “Classification”, “Generated Data”, and “Condition”. Each of the storage areas denoted by “#” stores a number assigned to each “Unit Of Manufacturing Management”, a sub-number assigned to the “Classification” of each unit of manufacturing management based on the number, or a sub-number assigned to “Generated Data” and “Condition” for each classification. The storage areas for “Unit Of Manufacturing Management” in the manufacturing result generation conditions 122 each store a unit of manufacturing management, such as “Process Step 1 for Workpiece Type A”, “Process Step 2 for Workpiece Type A”, “Process Step 1 for Workpiece Type B”, and the like. FIG. 5 is a diagram illustrating an example of a relationship between the facilities 20A and 20B and the process steps on a per workpiece type basis. FIG. 5 indicates that the process step 1 for the workpiece type A and the process step 1 for the workpiece type B are performed in the facility A, and the process step 2 for the workpiece type A is performed in the facility B. The process step 1 for the workpiece type A and the process step 1 for the workpiece type B include a pre-setup task (workpiece attachment/detachment, tool preparation, etc.) that is performed by an operator. The process step 2 for the workpiece type A includes a pre-setup task and a post-settlement task that are performed by an operator. The storage areas for “classification” in the manufacturing result generation conditions 122 each store, for example, “manufacturing result generation”, “machining”, “pre-setup”, “post-settlement”, and the like for each storage area for “unit of manufacturing management”. As illustrated in FIG. 5, the post-settlement task may be omitted depending on the workpiece type or the facility. In the storage areas for “Classification” in the manufacturing result generation conditions 122, “post-settlement” is omitted from the process step 1 for the workpiece type A and the process step 1 for the workpiece type B. The storage areas for “generated data” in the manufacturing result generation conditions 122 each store “manufacturing result generation (trigger) ”, “ID”, “unit of manufacturing management”, “facility”, “machining quantity”, “manufacturing result end”, “start time”, “end time”, “compensation value”, “tool used”, and the like in accordance with the storage areas for “unit of manufacturing management”. The storage areas for “condition” in the manufacturing result generation conditions 122 store, for each storage area for “generated data”, the conditions for acquiring the generated data. The manufacturing result generation conditions illustrated in FIG. 4 may include conditions related to the presence or absence of the manufacturing instructions from the production management system 30. As will be described later, the result generation condition setting unit 112 can create a new manufacturing result generation condition and can edit or delete an existing manufacturing result generation condition, based on an instruction inputted by an operator via the input unit 13 (to be described later).

The manufacturing results 123 include manufacturing results that are manufacturing data generated for each arbitrary unit of manufacturing management by the manufacturing result generation unit 113 (to be described later). This manufacturing data is generated from the manufacturing data 121 based on the manufacturing result generation conditions 122.

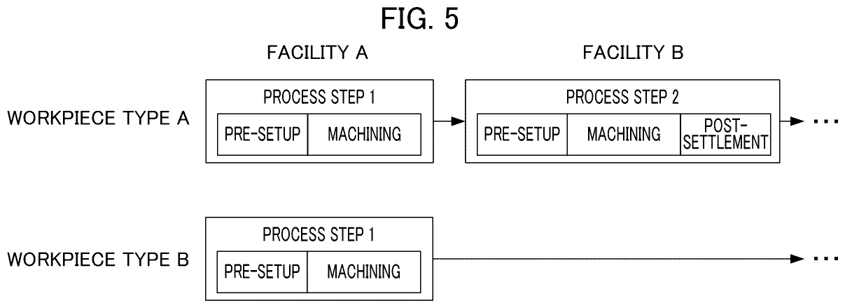

The association conditions 124 include association conditions that are set by the association condition setting unit 115 (to be described later) for associating the manufacturing results 123 and the manufacturing instructions 120 with each other. FIG. 6 is a table illustrating an example of the association conditions 124. As illustrated in FIG. 6, the association conditions 124 include storage areas for “Title of Condition”, “Association Condition Classification”, “Priority”, and “Condition”. The storage areas for “Title of Condition” in the association conditions 124 each store a unit of manufacturing management, such as “Process Step 1 for Workpiece Type A”, “Process Step 1 for Workpiece Type B”, “Workpiece Type C”, “Workpiece Type D”, and the like. The “Common Condition” is a preset condition, and the association unit 116 (to be described later) may attempt association with the “Common Condition” when no individual condition is met. The storage areas for “Association Condition Classification” in the association conditions 124 each store an object (e.g., a unit of manufacturing management, time, a facility, a quantity, a lot ID, a workpiece type, etc.) to be compared for association between the manufacturing instructions 120 and the manufacturing results 123. The storage areas for “Priority” in the association conditions 124 store the priority order (e.g., “1”, “2”, etc.) according to which the objects stored in the storage areas of “association condition classification” are to be compared. The smaller the numerical value, the higher the priority. However, a configuration in which the larger the numerical value, the higher the priority may be employed. The storage areas for “Condition” in the association conditions 124 store conditions for comparing the objects stored in the storage areas of “Association Condition Classification”. It should be noted that the association conditions 124 preferably include at least one of information regarding a manufactured product, information regarding a quantity of the manufactured product, information regarding manufacturing time of the manufactured product, information regarding a manufacturing method, information regarding manufacturing location and facility, information regarding a person responsible for manufacture, or the like.

The association outcomes 125 include the outcomes of associating the manufacturing instructions with the manufacturing results by the association unit 116 (to be described later).

### Input Unit 13

The input unit 13 is, for example, a keyboard or a touch panel provided on the display unit 14 (to be described later), and receives input from an operator.

### Display Unit 14

The display unit 14 is, for example, a liquid crystal display or the like. As will be described later, the display unit 14 may display a user interface (UI) that allows for setting the manufacturing result generation conditions 122 by means of the result generation condition setting unit 112, and a UI that allows for setting the association conditions 124 by means of the association condition setting unit 115 (to be described later). The display unit 14 may display a UI that allows for ascertainment of the manufacturing results 123 generated by the manufacturing result generation unit 113 (to be described later). The display unit 14 may display a UI that shows association outcomes of the association unit 116 (to be described later), and a UI that allows for correcting the association outcomes.

### Control Unit 11

The control unit 11 includes a central processing unit (CPU), a read only memory (ROM), a RAM, a complementary metal-oxide-semiconductor (CMOS) memory, and the like, which are configured to communicate with each other via a bus, and are known to those skilled in the art. The CPU is a processor that controls the manufacturing information management device 10 as a whole. The CPU reads a system program and application programs stored in the ROM via the bus, and controls the entire manufacturing information management device 10 in accordance with the system program and the application programs. Due to this configuration, as illustrated in FIG. 1, the control unit 11 is configured to implement the functions of the manufacturing instruction acquisition unit 110, the manufacturing data acquisition unit 111, the result generation condition setting unit 112, the manufacturing result generation unit 113, the manufacturing result acquisition unit 114, the association condition setting unit 115, and the association unit 116. The RAM stores various data such as temporary calculation data, display data, etc. The CMOS memory is backed up by a battery (not shown) and is configured as a non-volatile memory that maintains a storage state even when the manufacturing information management device 10 is turned off.

The manufacturing instruction acquisition unit 110 acquires manufacturing instructions for the facilities 20A and 20B from, for example, the production management system 30. The manufacturing instruction acquisition unit 110 outputs the acquired manufacturing instructions to the facilities 20A and 20B. Furthermore, the manufacturing instruction acquisition unit 110 stores the acquired manufacturing instructions in the manufacturing instructions 120.

The manufacturing data acquisition unit 111 acquires, from each of the facilities 20A and 20B, manufacturing data including at least the manufacture-related time-series data illustrated in FIG. 3. The manufacturing data acquisition unit 111 stores the manufacturing data acquired from each of the facilities 20A and 20B in the manufacturing data 121 for each of the facilities 20A and 20B.

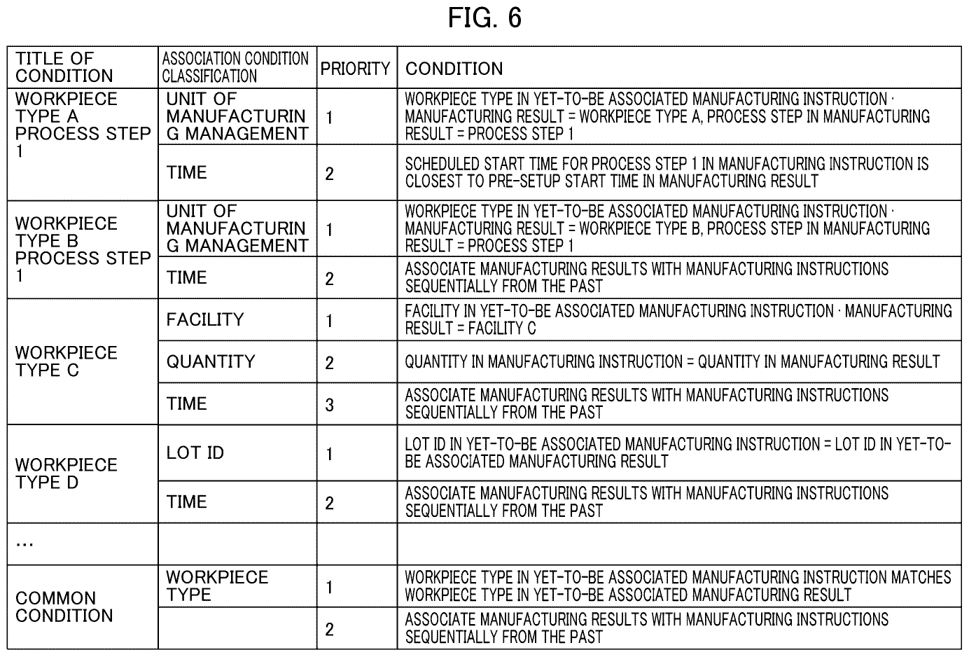

The result generation condition setting unit 112 sets the manufacturing result generation conditions illustrated in FIG. 4 based on, for example, an input operation by an operator via the input unit 13. Specifically, for example, upon receiving a setting instruction for setting a manufacturing result generation condition from the operator via the input unit 13, the result generation condition setting unit 112 displays, on the display unit 14, a result generation condition list screen that allows for setting the manufacturing result generation condition. FIG. 7 is a diagram illustrating an example of a result generation condition list screen 200. As illustrated in FIG. 7, the result generation condition list screen 200 is a user interface including a result generation condition list 210, a create button 220, an edit button 230, and a delete button 240. The result generation condition list 210 is a list of existing manufacturing result generation conditions and includes display areas for “Title of Condition”, “Result Generation Trigger Classification”, and “Operation Switching”. The display areas for “Title of Condition” in the result generation condition list 210 each display a workpiece type and a process step for each of the units of manufacturing management for which the manufacturing result generation conditions are set. The display areas for “Result Generation Trigger Classification” in the result generation condition list 210 each display the classification of a condition that triggers the manufacturing result generation (e.g., “machining program”, “torque command”, etc.). For example, referring to the manufacturing data 121 illustrated in FIG. 3, for “Workpiece Type A, Process Step 1” and “Workpiece Type B, Process Step 1”, a start of execution of the machining program “01000” and a start of execution of the machining program “02000” trigger the result generation. Accordingly, “Machining Program” is displayed in the respective display area for “Result Generation Trigger Classification” in the result generation condition list 210. For “Workpiece Type A, Process Step 2”, the result generation is determined based on a torque command, and accordingly, “Torque Command” is displayed in the display area for “Result Generation Trigger Classification” in the result generation condition list 210. The display areas for “Operation Switching” in the result generation condition list 210 each displays an “Operating” button or a “Stopped” button for switching the operation of generating a manufacturing result for the workpiece type and process step displayed in the display area for “Title of Condition”. For example, when the display area for “Operation Switching” displays the “Operating” button, it indicates that a manufacturing result for the corresponding workpiece type and process step is being generated. In response to an operator pressing the “Operating” button via the input unit 13, it switches to the “Stopped” button and the generation of manufacturing result for the corresponding workpiece type and process step stops. When the display area for “Operation Switching” displays the “Stopped” button, it indicates that generation of a manufacturing result for the corresponding workpiece type and process step is stopped. In response to the operator pressing the “Stopped” button via the input unit 13, it switches to the “Operating” button and the manufacturing result for the corresponding workpiece type and process step is generated.

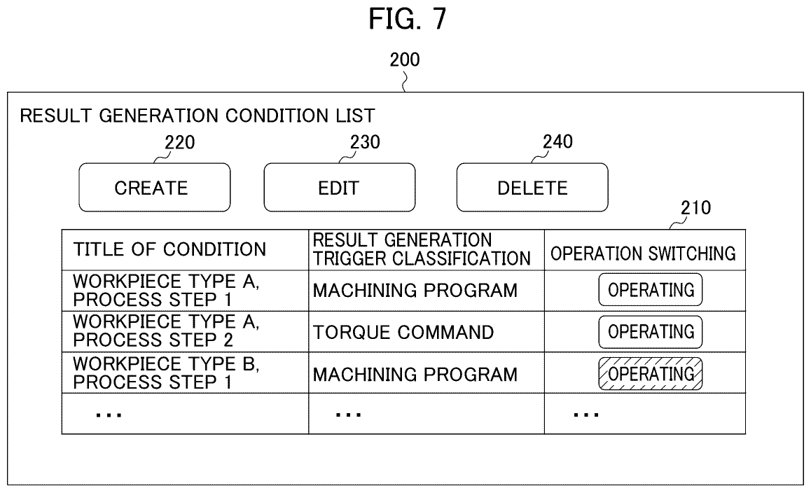

In response to the operator pressing the create button 220 via the input unit 13, the result generation condition setting unit 112 displays a new creation screen for creating a new manufacturing result generation condition on the display unit 14. FIG. 8 is a diagram illustrating an example of a new creation screen 300. FIG. 8 shows an example in which a manufacturing result generation condition for the unit of manufacturing management “Process Step 1 for Workpiece Type A” in FIG. 4 is newly created. As illustrated in FIG. 8, in the new creation screen 300, “Workpiece Type A, Process Step 1” is inputted in the field of “Title of Condition” in accordance with the operator's input operation. Here, the manufacturing result generation condition includes a result generation condition (trigger) for starting the generation of a manufacturing result itself and other conditions (e.g., “machining”, “pre-setup”, etc.). For the result generation condition (trigger), a manufacturing result generation (trigger) (i.e., manufacturing result generation start), manufacturing result end, and generated data are set. For the manufacturing result generation (trigger) and manufacturing result end, “Facility”, “Trigger Classification”, and “Condition” are set. For the generated data, “ID” as identification information that is assigned to the manufacturing result to be generated and identifies the manufacturing result, “Unit of Manufacturing Management” and “Facility” indicated by the manufacturing result, and the like are set. The operator may add an item to the conditions for manufacturing result generation (trigger), manufacturing result end, and generated data by pressing a plus (+) button. The operator may delete an item from the condition for the generated data by pressing a trash button. Although the “ID” of the generated data is a combination of a fixed value (e.g., “A_01”) and a serial number in the illustrated example, it may be only a serial number or a combination of a fixed value and date/time.

For other conditions, conditions/generation values for each classification, such as “machining” and “pre-setup” are set. The classification titles of the conditions/generation values may be prepared in advance and selected by the operator, or may be freely inputted by the operator. Alternatively, the conditions/generation values may describe what condition and what value are set for each item of the generated data in accordance with an input by the operator. Data used for setting the conditions/generation values and the like may be selected and specified by the operator from a list of the manufacturing data 121. In response to the operator pressing the “Create” button on the new creation screen 300 via the input unit 13, the result generation condition setting unit 112 stores the manufacturing result generation condition set on the new creation screen 300 in the manufacturing result generation conditions 122.

In response to the operator selecting one row from the result generation condition list 210 and pressing the edit button 230 via the input unit 13, the result generation condition setting unit 112 displays an edit screen for editing the selected manufacturing result generation condition on the display unit 14. The edit screen is similar to the new creation screen 300 in FIG. 8, and detailed description of the edit screen is omitted herein. In response to the operator selecting one or more manufacturing result generation conditions from the result generation condition list 210 and pressing the delete button 240 via the input unit 13, the result generation condition setting unit 112 deletes the selected manufacturing result generation conditions from the manufacturing result generation conditions 122.

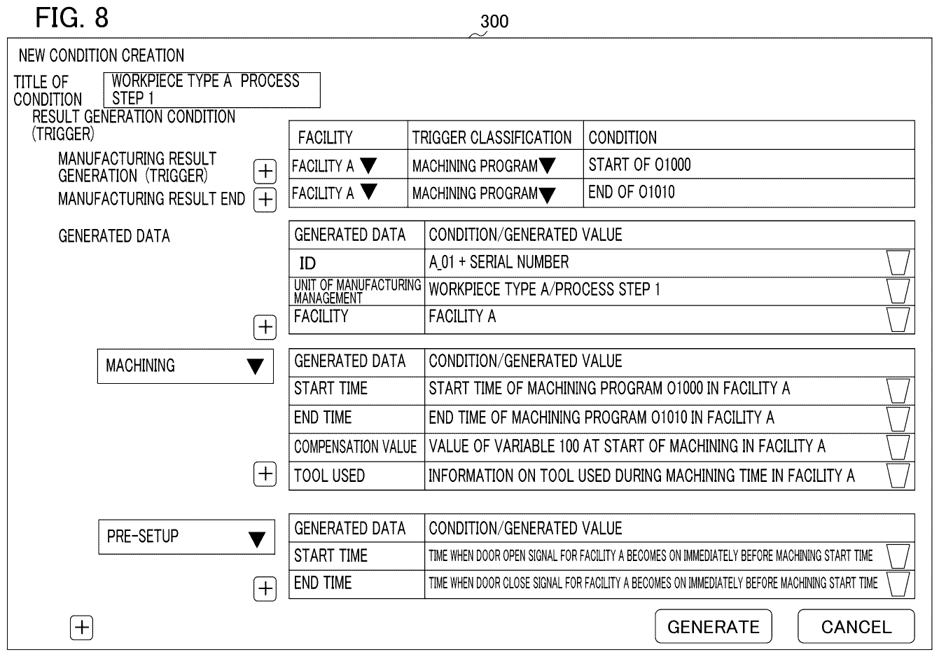

The manufacturing result generation unit 113 generates manufacturing data for each arbitrary unit of manufacturing management as a manufacturing result, from the manufacturing data 121 based on the manufacturing result generation conditions 122 set in advance, for example. Specifically, the manufacturing result generation unit 113 ascertains, for example, that in the manufacturing data 121 in FIG. 3, the machining program “01000” started in the facility A at time t3. Then, the manufacturing result generation unit 113 ascertain that a door open signal is “ON” at time t1 and a door close signal is “ON” at time t2 immediately before time t3, based on the manufacturing result generation condition for the unit of manufacturing management “Process Step 1 for Workpiece Type 1” included in the manufacturing result generation conditions 122 in FIG. 4. The manufacturing result generation unit 113 ascertains that the machining program “01010” ends at time t4, based on the manufacturing result generation condition for the unit of manufacturing management “Process Step 1 for Workpiece Type 1” in FIG. 4. In this way, the manufacturing result generation unit 113 generates “Manufacturing Result 1” illustrated in FIG. 9, in which “ID” is “A_01_00001”, “Unit of Manufacturing Management” is “Workpiece Type A” and “Process Step 1”, “Facility” is “Facility A”, “Pre-Setup Time” is “t1 to t2”, “Machining Time” is “t3 to t4”, “Compensation Value” is “0.2” that is a value of a variable 100 at the machining start point t3, and “Used Tools” are “T1, T2”, and so on. The manufacturing result generation unit 113 stores the generate manufacturing result in the manufacturing results 123.

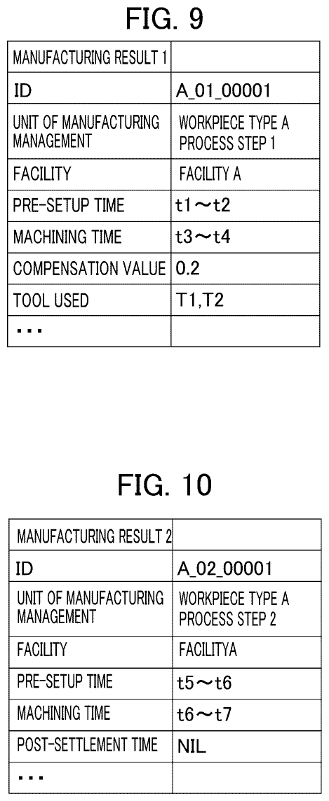

Further, the manufacturing result generation unit 113 ascertains that, in the manufacturing data 121 in FIG. 3, the signal A for the facility B became “ON” at time to, and from this point in time, the torque command was equal to or greater than a given value for a given period of time or longer. Then, the manufacturing result generation unit 113 ascertains that the signal B becomes “ON” at time t5 immediately before time t6, based on the manufacturing result generation condition for the unit of manufacturing management “Process Step 2 for Workpiece Type 1” included in the manufacturing result generation conditions 122 in FIG. 4. The manufacturing result generation unit 113 further ascertains that the torque command becomes less than the given value at time t7, based on the manufacturing result generation condition for the unit of manufacturing management “Process Step 2 of Workpiece Type 1” in FIG. 4. In this way, the manufacturing result generation unit 113 generates “Manufacturing Result 2” illustrated in FIG. 10, in which “ID” is “A_02_00001”, “Unit Of Manufacturing Management” is “Workpiece Type A” and “Process Step 2”, “Facility” is “Facility B”, “Pre-Setup Time” is “t5 to t6”, “Machining Time” is “t6 to t7”, and “Post-Settlement Time” is “nil”, and so on. The manufacturing result generation unit 113 stores the generated manufacturing result in the manufacturing results 123. The manufacturing result generation unit 113 determines the post-settlement time by executing a determination program stored (registered) in advance in the storage unit 12. Then, the manufacturing result generation unit 113 sets “nil” in the “Post-Setup Time” of the manufacturing result in FIG. 10 because the manufacturing result generation unit 113 has determined the post-setup time as “nil (0)” based on the result of the determination.

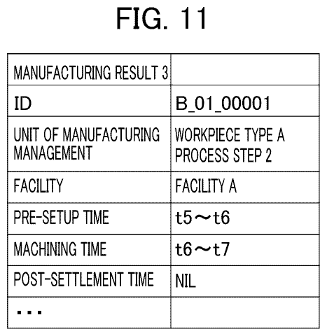

Further, the manufacturing result generation unit 113 ascertains that in the manufacturing data 121 in FIG. 3, the machining program “02000” started at time t10 in the facility A. Then, the manufacturing result generation unit 113 ascertains that the door open signal is “ON” at time t8 and the door close signal is “ON” at time t9 immediately before time t10, based on the manufacturing result generation condition for the unit of manufacturing management “Process Step 1 for workpiece type B” included in the manufacturing result generation conditions 122 in FIG. 4. The manufacturing result generation unit 113 further ascertains that the machining program “02000” ends at time t11, based on the manufacturing result generation condition for the unit of manufacturing management “Process Step 1 for workpiece type 2” in FIG. 4. In this way, the manufacturing result generation unit 113 generates “Manufacturing Result 3” illustrated in FIG. 11, in which “ID” is “B_01_00001”, “Unit of Manufacturing Management” is “Workpiece Type B” and “Process Step 1”, “Facility” is “Facility A”, “Pre-Setup Time” is “t8 to t9”, and “Machining Time” is “t10 to t11”. The manufacturing result generation unit 113 stores the generated manufacturing result in the manufacturing results 123.

Next, after generating the manufacturing results based on the manufacturing result generation conditions, the manufacturing result generation unit 113 calculates an index (score) that indicates a probability of each of the generated manufacturing results. In the following, a case (a) where the score (up to 100) indicating the probability of the manufacturing result generation is calculated from comparison with a standard lead time and a case (b) where the score is calculated from a degree of similarity of a torque command will be described as examples.

### (a) Case of Calculating the Score From Comparison With Standard Lead Time

The manufacturing result generation unit 113 sets in advance a standard lead time S and a standard deviation o thereof for each period of time (type of period of time) subjected to the score calculation, such as the “Machining Time” of “Process Step 1 for Workpiece Type A” in the manufacturing result illustrated in FIG. 9. The manufacturing result generation unit 113 may calculate the score in accordance with the following equation:
Score=100−(|S−t|/σ)×α, where
t is the machining time of the generated manufacturing result (t=end time−start time), and α is an arbitrary constant.

In a case where there are multiple periods of time to be subjected to the calculation, the manufacturing result generation unit 113 may calculate the average value of the scores of the multiple periods of time as the score.

### (b) Case of Calculating the Score From a Degree of Similarity of Torque Command

In this case, for example, it is assumed that a model pattern of a torque command pertaining to each type of period of time of the respective unit of manufacturing management is stored (registered) in advance in the storage unit 12. When generating a manufacturing result, the manufacturing result generation unit 113 acquires time-series data of a torque command for each type of period of time (e. g., the machining time, etc.) from the manufacturing data 121, based on the set manufacturing result generation conditions. The manufacturing result generation unit 113 calculates a degree of similarity between the acquired time-series data and the stored (registered) model pattern. The manufacturing result generation unit 113 may calculate the score by normalizing the calculated degree of similarity using known techniques (e.g., cross-correlation function (CCF), dynamic time warping (DTW), etc.).

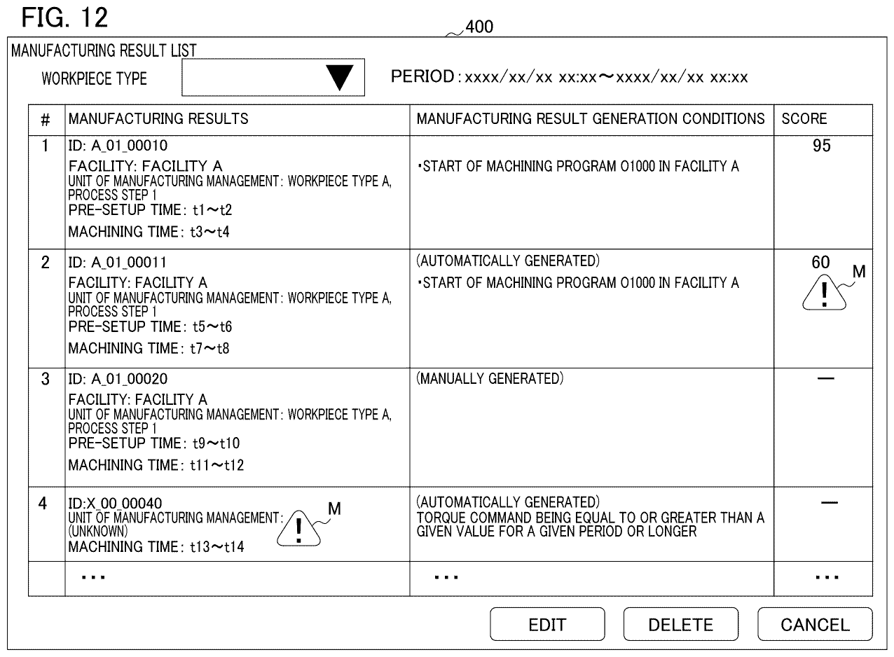

The manufacturing result generation unit 113 displays, on the display unit 14, a manufacturing result list screen that shows the list of generated manufacturing results, the manufacturing result generation conditions, and the calculated scores. FIG. 12 is a diagram illustrating an example of a manufacturing result list screen 400. As illustrated in FIG. 12, the manufacturing result list screen 400 is a user interface that has display areas for “Manufacturing Result”, “Manufacturing Result Generation Conditions”, and “Score”, and allows for filtering of the manufacturing results to be displayed by an arbitrary condition such as a period, a workpiece type, and a score. The display areas for “Manufacturing Result” in the manufacturing result list screen 400 each display information regarding the generated manufacturing result. The display areas for “Manufacturing Result Generation Conditions” in the manufacturing result list screen 400 each display the manufacturing result generation condition based on which the manufacturing result has been generated. The display area for “Manufacturing Result Generation Conditions” displays “Automatically Generated” together with a manufacturing result automatically generated based on a manufacturing result generation condition, and displays “Manually Generated” together with a manufacturing result manually inputted by an operator. The manufacturing result generation unit 113 may exclude the manually generated manufacturing result from the score calculation. In a case where the unit of manufacturing management is unknown at the time of generating a manufacturing result, the manufacturing result generation unit 113 may indicate that the unit of manufacturing management is “Unknown” and display an attention attracting mark M, thereby prompting the operator to ascertain the unit of manufacturing management and the like. In this case, in response to the operator pressing the “Edit” button via the input unit 13, the manufacturing result generation unit 113 may correct the unit of manufacturing management and the like based on the outcome of the operator's ascertainment. The display areas for “Score” in the manufacturing result list screen 400 each display the score indicating the probability calculated by the manufacturing result generation unit 113. For a manufacturing result with a low score, such as 60 or less, the manufacturing result generation unit 113 may display, for example, an attention attracting mark M to prompt the operator to ascertain the correspondence between the manufacturing result and the manufacturing data 121 or the manufacturing result generation conditions 122, or the like. In this case, in response to the operator pressing the “Edit” button via the input unit 13, the manufacturing result generation unit 113 may correct the manufacturing result and the like based on the outcome of the operator's ascertainment.

The manufacturing result acquisition unit 114 acquires manufacturing results such as those illustrated in FIGS. 9 to 11 from the manufacturing results 123.

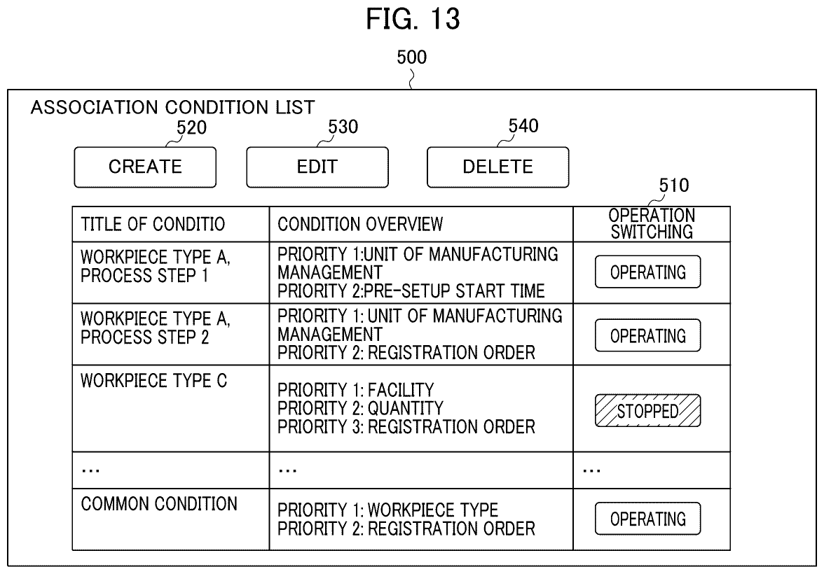

The association condition setting unit 115 sets the association conditions 124 for the association unit 116 (to be described later) to associate the manufacturing instructions included in the manufacturing instructions 120 with the manufacturing results acquired by the manufacturing result acquisition unit 114, for example. Specifically, upon receiving an association condition setting instruction from the operator via, for example, the input unit 13, the association condition setting unit 115 displays an association condition list screen for setting association conditions on the display unit 14. FIG. 13 is a diagram illustrating an example of an association condition list screen 500. As illustrated in FIG. 13, the association condition list screen 500 is a user interface having an association condition list 510, a create button 520, an edit button 530, and a delete button 540. The association condition list 510 displays a list of existing association conditions and has display areas for “Title of Condition”, “Condition Overview”, and “Operation Switching”. The display areas for “Title of Condition” in the association condition list 510 each display a workpiece type and a process step for each of the units of manufacturing management for which association conditions are set, a workpiece type, “Common Conditions”, etc. The display areas for “Condition Overview” in the association condition list 510 display, with indication of priority, comparison targets (e. g., a unit of manufacturing management, setup start time, an order of registration, a facility, a quantity, a workpiece type, etc.) set for associating a manufacturing instruction with a manufacturing result. The display areas for “Operation Switching” in the association condition list 510 each display an “Operating” button or “Stopped” button for switching the operation for associating a manufacturing result with the manufacturing instruction for the workpiece type and process step displayed in the “Title of Condition” display area. For example, when the display area for “Operation Switching” displays the “Operating” button, it indicates that determination based on the association conditions is automatically performed on the manufacturing instruction inputted in real time for the workpiece type and process step and the manufacturing result, and that when the manufacturing instruction matches the manufacturing result match, they are associated with each other. In response to the operator pressing the “Operating” button via the input unit 13, it switches to the “Stopped” button, and the associating the manufacturing instruction with the manufacturing result for the workpiece type and process step stops. When the display area for “Operation Switching” displays the “Stopped” button, it indicates that associating the manufacturing instruction with the manufacturing result for the workpiece type and process step is stopped. In response to the operator pressing the “Stopped” button via the input unit 13, it switches to the “Operating” button, and the manufacturing instruction and the manufacturing result for the workpiece type and process step are associated with each other.

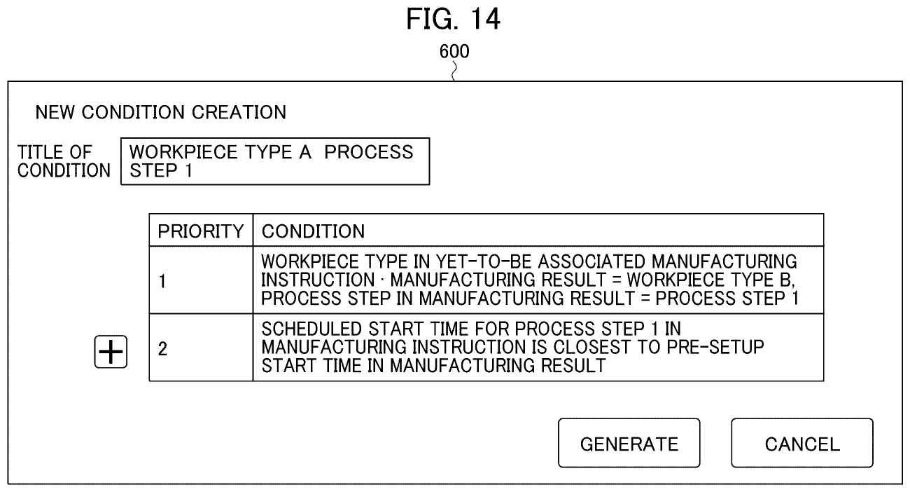

In response to the operator pressing the create button 520 via the input unit 13, the association condition setting unit 115 displays a new creation screen for creating a new association condition on the display unit 14. FIG. 14 is a diagram illustrating an example of a new creation screen 600. FIG. 14 shows an example in which an association condition for “Workpiece Type A, Process Step 1” in FIG. 6 is newly created. As illustrated in FIG. 14, in the new creation screen 600, “Workpiece Type A, Process Step 1” is input in the field of “Title of Condition” in accordance with the operator's input operation. When the plus (+) button is pressed by the operator via the input unit 13, input fields for “Priority” and “Condition” are added, and “Conditions” are set for each “Priority” in accordance with the operator's input operation. In response to the operator pressing the “Create” button on the new creation screen 600 via the input unit 13, the association condition setting unit 115 stores the association condition set on the new creation screen 600 in the association conditions 124.

The association unit 116 associates the manufacturing instruction included in the manufacturing instructions 120 with the manufacturing result included in the manufacturing results 123 based on, for example, the preset association conditions 124. In the following, a case of associating the manufacturing result shown in “Manufacturing Result 1” in FIG. 9 with the corresponding manufacturing instruction based on the association conditions in FIG. 6 will be described as an example. However, another manufacturing result is associated with a corresponding manufacturing instruction in the same manner as in the case of associating the manufacturing result in FIG. 9 with a manufacturing instruction. Specifically, the association unit 116 extracts a plurality of manufacturing instructions including the manufacturing instructions illustrated in FIGS. 2A and 2C from the manufacturing instructions 120, based on the association conditions having priority “1” in FIG. 6 and matching the manufacturing result in FIG. 9: for example, the association condition in which “Workpiece Type A” has priority “1”. Based on the extracted plurality of manufacturing instructions and the condition with priority “2” pertaining to the association condition that “Workpiece Type A” has priority “1”, the association unit 116 associates, for example, the manufacturing result of FIG. 9 with the manufacturing instruction of FIG. 2A in which the scheduled start time for the process step 1 is closest to the pre-setup start time t1 in the manufacturing result of FIG. 9. Then, the association unit 116 stores the ID of the manufacturing instruction of FIG. 2A and the ID of the manufacturing result of FIG. 9 in combination with each other in the association outcomes 125. Further, the association unit 116 updates the association outcomes 125 to indicate that the association state of the manufacturing result of FIG. 9 is “Associated”.

Next, after associating the manufacturing instruction with the manufacturing result based on the association conditions 124, the association unit 116 calculates an index (score) that indicates a probability of each outcome of association. Specifically, the association unit 116 calculates the score (up to 100) indicating the probability of the association of a manufacturing instruction and a manufacturing result. The association unit 116 sets in advance a standard deviation time S′, which is the average time of deviation between the scheduled start time of the manufacturing instruction and the actual start time, and a standard deviation σ′ thereof, for each period of time to be managed by the unit of manufacturing management. The association unit 116 may calculate the score in accordance with the following equation:
Score=100−(|S′−t|/σ′)×β, where t is a difference in time between the manufacturing instruction and the manufacturing result associated with each other, and βis an arbitrary constant.
   In a case where there are multiple periods of time to be subjected to the calculation, the association unit 116 may calculate the average value of the scores of the multiple periods of time as the score.

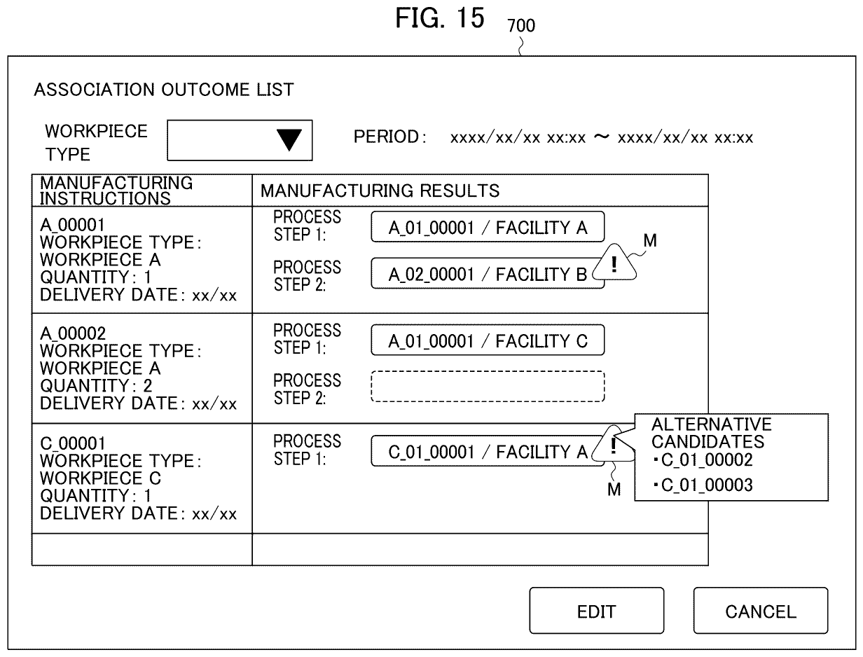

The association unit 116 refers to the association outcomes 125 and displays on the display unit 14 an association outcome list screen showing a list of the associated manufacturing instructions and manufacturing results. FIG. 15 is a diagram illustrating an example of an association outcome list screen 700. As illustrated in FIG. 15, the association outcome list screen 700 is a user interface that has display areas for “Manufacturing Instructions” and “Manufacturing Results” and allows for filtering of the association outcomes to be displayed based on arbitrary conditions such as a period, a workpiece type, etc. The display areas for “Manufacturing Instructions” in the association outcome list screen 700 each display information regarding the associated manufacturing result. Each display area for “Manufacturing Instructions” displays “ID”, “Workpiece Type”, “Quantity”, and “Delivery Date” included in the manufacturing instruction. The display areas for “Manufacturing Results” in the association outcome list screen 700 each display, in correspondence with the manufacturing instruction displayed in the display area for “Manufacturing Instructions”, information regarding the associated manufacturing result, such as the ID, the facility, and the like for each process step (unit of manufacturing management). In a case where any manufacturing result cannot be associated with the manufacturing instruction with “ID” of “A_00002”,“Workpiece Type” of “Workpiece A”, “Quantity” of “2”, and “Delivery Date” of “xx/xx”, the association unit 116 may display a blank field in “Process Step 2”, for example. Further, in a case where the score calculated for the association between a manufacturing instruction and a manufacturing result is equal to or less than a predetermined value (e.g., 60), the association unit 116 may display a mark M that prompts the operator to ascertain the association between the manufacturing instruction and the manufacturing result. In this case, the association unit 116 may display association candidates of alternative manufacturing results on the association outcome list screen 700 in response to the operator positioning a cursor on the mark M via the input unit 13. For example, when the operator clicks on the display area with the mark M or the association candidate of the alternative manufacturing result in the row of the manufacturing instruction with “ID” of “C_00001”, “Workpiece Type” of “Workpiece C”, “Quantity” of “2”, and “Delivery Date” of “xx/xx” on the association outcome list screen 700, the association unit 116 may display a manufacturing result association change screen on the display unit 14.

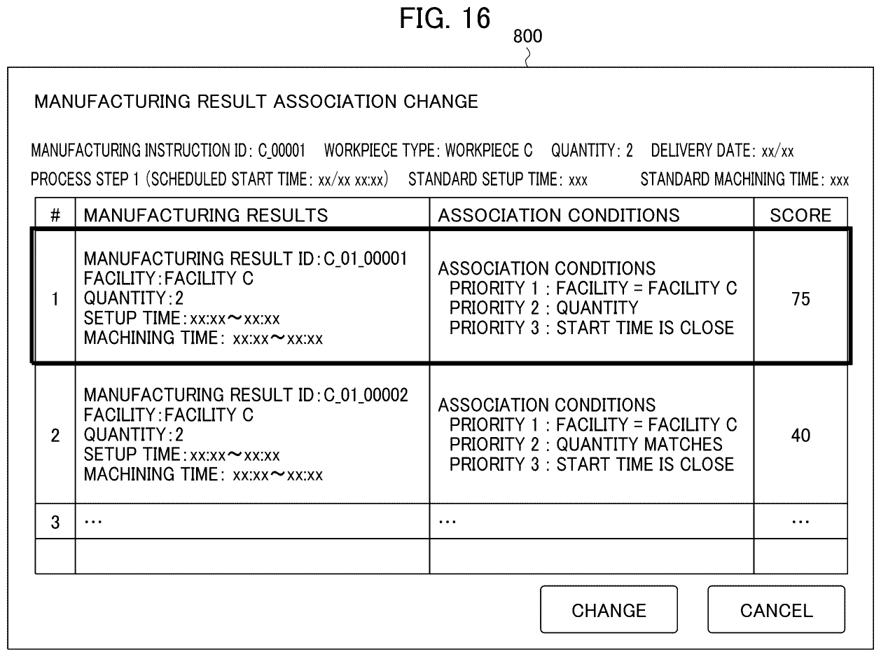

FIG. 16 is a diagram illustrating an example of a manufacturing result association change screen 800. As illustrated in FIG. 16, the manufacturing result association change screen 800 is a user interface that displays a list of manufacturing result candidates for association with the manufacturing instruction with “ID” of “C_00001”, “Workpiece Type” of “Workpiece C”, “Quantity” of “2”, “Delivery Date” of “xx/xx”, and the like, and allows for changing the manufacturing result to be associated with the manufacturing instruction by selecting another manufacturing result from the candidates. The manufacturing result association change screen 800 has display areas for “Manufacturing Candidates”, “Association Conditions”, and “Score”. The display areas for “Manufacturing Results” in the manufacturing result association change screen 800 each display information (e.g., an ID, a facility, a quantity, a setup time, a machining time, etc.) regarding each of the manufacturing result candidates for association. The display areas for “Association Conditions” in the manufacturing result association change screen 800 display the association condition according to which the manufacturing result as the candidate is associated. The display areas for “Score” in the manufacturing result association change screen 800 display a score calculated for each of the manufacturing result candidates for association, calculated by the association unit 116. When the operator selects a more appropriate manufacturing result for the manufacturing instruction, as indicated by the thick rectangular line in the manufacturing result association change screen 800 and presses the “Change” button, the association unit 116 changes the manufacturing result to be associated with the manufacturing instruction and updates the association outcomes 125.

### Operation of Manufacturing Information Management Device 10

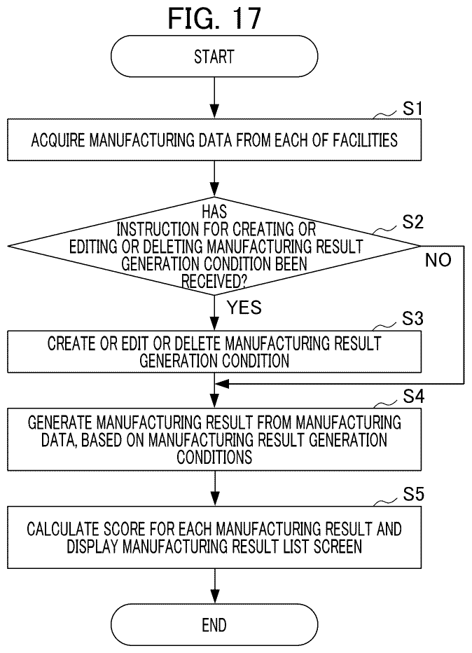

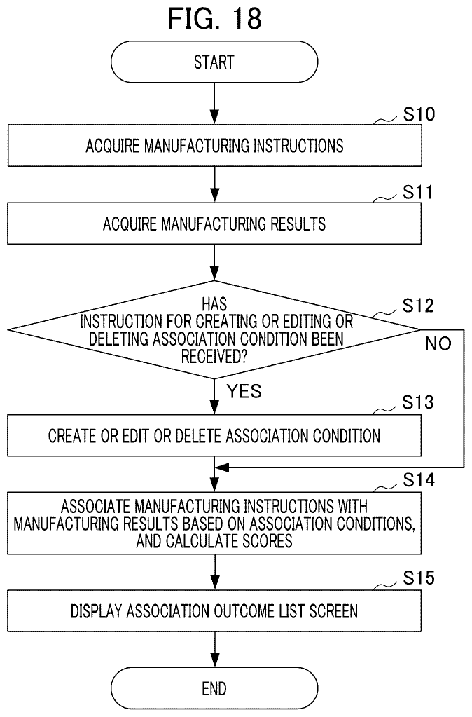

Next, the operation of the manufacturing information management device 10 will be described with reference to FIGS. 17 and 18. FIG. 17 is a flowchart illustrating manufacturing result generation processing by the manufacturing information management device 10. FIG. 18 is a flowchart illustrating association processing by the manufacturing information management device 10. It should be noted that the processing illustrated in FIG. 17 and the processing illustrated in FIG. 18 may be performed sequentially or in parallel.

First, the manufacturing result generation processing by the manufacturing information management device 10 will be described with reference to FIG. 17. In Step S1, the manufacturing data acquisition unit 111 acquires manufacturing data including at least the manufacture-related time-series data illustrated in FIG. 3 from each of the facilities 20A and 20B. The manufacturing data acquisition unit 111 stores the manufacturing data acquired from each of the facilities 20A and 20B in the manufacturing data 121 for each of the facilities 20A and 20B.

In Step S2, the result generation condition setting unit 112 determines whether or not an instruction for creating a new manufacturing result generation condition or an instruction for editing or deleting an existing manufacturing result generation condition has been received from an operator via the input unit 13. When the instruction for the creation or the instruction for the editing or deletion has been received, the processing proceeds to Step S3. On the other hand, when the instruction for the creation or the instruction for the editing or deletion has not been received, the processing proceeds to Step S4.

In Step S3, the result generation condition setting unit 112 creates the new manufacturing result generation condition, or edits or deletes the existing manufacturing result generation condition based on the input operation by an operator via the input unit 13.

In Step S4, the manufacturing result generation unit 113 generates manufacturing data for each unit of manufacturing management from the manufacturing data 121 as manufacturing results, based on the manufacturing result generation conditions 122.

In Step S5, the manufacturing result generation unit 113 calculates a score for each manufacturing result generated in Step S4 and displays the manufacturing result list screen 400 on the display unit 14. The manufacturing result generation unit 113 corrects the manufacturing results and the like based on an input operation by the operator via the input unit 13.

Next, the association processing by the manufacturing information management device 10 will be described with reference to FIG. 18. In Step S10, the manufacturing instruction acquisition unit 110 acquires manufacturing instructions for the facilities 20A and 20B from the production management system 30.

In Step S11, the manufacturing result acquisition unit 114 acquires manufacturing results from the manufacturing results 123.

In Step S12, the association condition setting unit 115 determines whether or not an instruction for newly creating an association condition or an instruction for editing or deleting an existing association condition has been received from an operator via the input unit 13. When the instruction for the creating or the instruction for the editing or deletion has been received, the processing proceeds to Step S13. On the other hand, when the instruction for the creation or the instruction for the editing or deletion has not been received, the processing proceeds to Step S14.

In Step S13, the association condition setting unit 115 creates the new association condition or edits or deletes the existing association condition based on the input operation by the operator via the input unit 13.

In Step S14, the association unit 116 associates the manufacturing instructions and the manufacturing results based on the association conditions 124, and calculates scores indicating probabilities of the manufacturing instructions and the manufacturing results associated with each other.

In Step S15, the association unit 116 displays on the display unit 14 the association outcome list screen 700 showing the outcomes of association between the manufacturing instructions and the manufacturing results associated with each other in Step S14. The association unit 116 performs correction and the like of the association between the manufacturing instructions and the manufacturing results based on an input operation by the operator via the input unit 13.

In the above-described manner, the manufacturing information management device 10 according to the embodiment can easily organize the manufacturing instructions from the production management system and the manufacturing results achieved in the facilities by associating them with each other. Furthermore, the manufacturing information management device 10 associates the manufacturing instructions and the manufacturing results in no particular order (asynchronously) based on preset association conditions (which means that there is no need for an operator to be conscious of a manufacturing result at the time of issuing a manufacturing instruction, and a result is achieved without the operator being conscious of a manufacturing instruction). As a result, it is possible to organize accurate manufacturing result data associated with manufacturing instructions. Furthermore, the manufacturing information management device 10 can address a case where there are a plurality of facilities capable of performing an instructed process step, and it has not been determined which of the facilities will perform the machining at the time of issuance of the instruction. Furthermore, since the association between items of the organized data can be referenced in real time, a progress status of the processing performed in accordance with a manufacturing instruction can be grasped in real time. Furthermore, the organized data can be utilized as traceability data associated with a workpiece. Furthermore, the organized data can be used for ascertaining an operation time for each workpiece, grasping variations, and accurately collecting a setup time, a machine operation time, and the like necessary for calculating the cost of each workpiece.

### Modification 1

In the embodiment described above, the manufacturing information management device 10 acquires manufacturing data from the facilities 20A and 20B, but this is a non-limiting example. For example, the manufacturing information management device 10 may acquire various data related to workpieces, such as data from sensors provided in the facilities 20A and 20B and observations by operators, and may associate them with manufacturing instructions.

### Modification 2

For example, in the embodiment described above, the manufacturing information management device 10 displays the outcomes of association between the manufacturing instructions and the manufacturing results on the association outcome list screen 700, but this is a non-limiting example. For example, the manufacturing information management device 10 may also display scores indicating the probabilities of the association outcomes together with the outcomes of association between the manufacturing instructions and the manufacturing results on the association outcome list screen 700.

It should be noted that the functions included in the manufacturing information management device 10 in the first embodiment can be implemented by hardware, software, or a combination thereof. Here, the implementation by software means that a computer reads and executes a program for the implementation.

The program can be stored in various types of non-transitory computer readable media and can be provided to a computer. The non-transitory computer readable media include various types of tangible storage media. Examples of the non-transitory computer readable media include a magnetic recording medium (e. g., a flexible disk, a magnetic tape, and a hard disk drive), a magnetic-optical recording medium (e.g., a magnetic optical disk), a read only memory (CD-ROM), a CD-R, a CD-R/W, and a semiconductor memory (e. g., a mask ROM, a programmable ROM (PROM), an erasable PROM (EPROM), a flash ROM, and a RAM). Furthermore, the program may be provided to the computer by way of various types of transitory computer readable media. Examples of the transitory computer readable media include an electrical signal, an optical signal, and an electromagnetic wave. Transitory computer readable medium can provide a program to the computer through a wired communication path, such as a wire and an optical fiber, or through a wireless communication path.

Steps of describing the program to be recorded on a recording medium include not only processes that are executed in time sequence in the order, but also processes that are executed in parallel or individually and not necessarily in time sequence. Furthermore, the steps of describing a program may be performed by cloud computing.

Although the present disclosure has been described in detail, the present disclosure is not limited to the individual embodiments described above. Various additions, replacements, modifications, partial deletions, and the like can be made to the above-described embodiments without deviating from the spirit of the present disclosure or without deviating from the spirit of the present disclosure derived from the contents of the claims and equivalents thereof. The above-described embodiments may also be implemented in combination. For example, in the above-described embodiments, the order of the operations and the order of the processing have been described as non-limiting examples. The same applies to a case where numerical values or mathematical formulas are used in the description of the embodiments described above.

The following further discloses additional remarks regarding the foregoing embodiments and the modification thereof.

### Additional Remark 1

A manufacturing information management device (10) includes: a manufacturing instruction acquisition unit (110) that acquires manufacturing instructions for facilities (20A, 20B) ; a manufacturing result acquisition unit (114) that acquires manufacturing results achieved in the facilities (20A, 20B) ; and an association unit (116) that associates the manufacturing instructions with the manufacturing results based on preset association conditions.

### Additional Remark 2

In the manufacturing information management device (10) of Additional Remark 1, the manufacturing results acquired by the manufacturing result acquisition unit (114) are information composed of a set of data items related to results of manufacture on a per unit of manufacturing management basis, and include at least time-related information on the per unit of manufacturing management basis.

### Additional Remark 3

In the manufacturing information management device (10) of Additional Remark 1, the association conditions include at least one of: information regarding a manufactured product, information regarding a quantity of the manufactured product, information regarding a manufacturing time of the manufactured product, information regarding a manufacturing method, information regarding manufacturing location and facility, or information regarding a person responsible for manufacture.

### Additional Remark 4

In the manufacturing information management device (10) of Additional Remark 1, the manufacturing instructions acquired by the manufacturing instruction acquisition unit are information related to manufacturing plans on the per unit of manufacturing management basis, and include at least one of: information regarding a manufactured product, information regarding a quantity of the manufactured product, information regarding a manufacturing time of the manufactured product, information regarding a manufacturing method, information regarding manufacturing location and facility, and information regarding a person responsible for manufacture.

### Additional Remark 5

The manufacturing information management device (10) of Additional Remark 1 includes an association condition setting unit (115) that sets the association conditions for the association unit (116) to associate the manufacturing instructions with the manufacturing results.

### Additional Remark 6

The manufacturing information management device (10) of Additional Remark 1 includes a display unit (14) that displays an association outcome of association between the manufacturing instructions and the manufacturing results, and the association unit (116) corrects the association outcome

### Additional Remark 7

In the manufacturing information management device (10) of Additional Remark 6, the association unit (116) calculates a value indicating a probability of the association outcome, and the display unit (14) displays the value calculated and indicating the probability of the association outcome together with the association outcome.

### Additional Remark 8

In the manufacturing information management device (10) of Additional Remark 6, the association unit (116) allows for selection of a manufacturing result to be associated with the manufacturing instruction, from a plurality of candidates in the association outcome.

### Additional Remark 9

A manufacturing information management method is for causing a computer to function as a manufacturing information management device (10), and includes: a manufacturing instruction acquisition step of acquiring manufacturing instructions for facilities (20A, 20B) ; a manufacturing result acquisition step of acquiring manufacturing results achieved in the facilities (20A, 20B) ; and an association step of associating the manufacturing instructions with the manufacturing results based on preset association conditions.

### Explanation of Reference Numerals

10: Manufacturing information management device
11: Control unit
110: Manufacturing instruction acquisition unit
111: Manufacturing data acquisition unit
112: Result generation condition setting unit
113: Manufacturing result generation unit
114: Manufacturing result acquisition unit
115: Association condition setting unit
116: Association unit
12: Storage unit
120: Manufacturing instructions
121: Manufacturing data
122: Manufacturing result generation conditions
123: Manufacturing results
124: Association conditions
125: Association outcomes
13: Input unit
14: Display unit
20A, 20B: Facility
30: Production management system
100: Manufacturing information management system

1. A manufacturing information management device comprising:
a manufacturing instruction acquisition unit that acquires manufacturing instructions for a facility;
a manufacturing result acquisition unit that acquires manufacturing results achieved in the facility; and
an association unit that associates the manufacturing instructions with the manufacturing results based on preset association conditions.

2. The manufacturing information management device according to claim 1, wherein the manufacturing results acquired by the manufacturing result acquisition unit are information composed of a set of data items related to results of manufacture on a per unit of manufacturing management basis, and include at least time-related information on the per unit of manufacturing management basis.

3. The manufacturing information management device according to claim 1, wherein the association conditions include at least one of: information regarding a manufactured product, information regarding a quantity of the manufactured product, information regarding a manufacturing time of the manufactured product, information regarding a manufacturing method, information regarding manufacturing location and facility, or information regarding a person responsible for manufacture.

4. The manufacturing information management device according to claim 1, wherein the manufacturing instructions acquired by the manufacturing instruction acquisition unit are information related to manufacturing plans on the per unit of manufacturing management basis, and include at least one of: information regarding a manufactured product, information regarding a quantity of the manufactured product, information regarding a manufacturing time of the manufactured product, information regarding a manufacturing method, information regarding manufacturing location and facility, or information regarding a person responsible for manufacture.

5. The manufacturing information management device according to claim 1, further comprising:
an association condition setting unit that sets the association conditions for the association unit to associate the manufacturing instructions with the manufacturing results.

6. The manufacturing information management device according to claim 1, further comprising:
a display unit that displays an association outcome of association between the manufacturing instructions and the manufacturing results, wherein
the association unit corrects the association outcome.

7. The manufacturing information management device according to claim 6, wherein
the association unit calculates a value indicating a probability of the association outcome, and
the display unit displays the value calculated and indicating the probability of the association outcome together with the association outcome.

8. The manufacturing information management device according to claim 6, wherein the association unit allows for selection of a manufacturing result to be associated with the manufacturing instruction, from a plurality of candidates in the association outcome.

9. A manufacturing information management method for causing a computer to function as a manufacturing information management device, the manufacturing information management method comprising:
a manufacturing instruction acquisition step of acquiring manufacturing instructions for a facility;
a manufacturing result acquisition step of acquiring manufacturing results achieved in the facility; and
an association step of associating the manufacturing instructions with the manufacturing results based on preset association conditions.
